(19) United States
(12) Patent Application Publication
(10) Pub. No.: US 2020/0097069 A1
(43) Pub. Date: Mar. 26, 2020

(54) Virtual Reality Input Device

(71) Applicant: Aaron Schradin, West Olive, MI (US)

(72) Inventor: Aaron Schradin, West Olive, MI (US)

(21) Appl. No.: 16/577,334

(22) Filed: Sep. 20, 2019

Related U.S. Application Data
(60) Provisional application No. 62/734,225, filed on Sep. 20, 2018.

(51) Int. Cl. G06F 3/01; G06T 19/00; G02B 27/01; A63F 13/211; A63F 13/213

(52) U.S. Cl. CPC G06F 3/011; G06T 19/006; G02B 27/017; G02B 2027/014; A63F 13/211; A63F 13/213; G02B 2027/0178; G06F 3/017

(57) ABSTRACT

An input device for providing seated user input to a computing device includes a seat portion and a processor and sensor package allowing a user to sit on the seat. The input device further includes several positional sensors that detect changes in pitch, yaw and roll and convert those detected changes to a control signal for operating functions on a computing device and/or providing input to applications running on the computing device.

### CROSS-REFERENCE TO RELATED APPLICATION

This application claims the benefit of U.S. Provisional Application No. 62/734,225 filed on Sep. 20, 2018. The entire disclosure of the above application is incorporated herein by reference.

### FIELD OF THE INVENTION

The present invention relates to devices and methods for providing interactive control of a computing device by a seated user. More particularly a chest mounted sensor system device for providing input for a computing device.

### BACKGROUND OF THE INVENTION

In order for humans to interact and operate computers, external input devices are generally required. Signals from these external input devices are received by the computer and processed to act as a control signal for controlling an aspect of the computer's function and/or applications (programs) running on the computer.

Traditionally, input devices such as keyboards, mice, game controllers and the like have focused on receiving input movements from the hands and particularly the fingers of users. While these have proven effective, they are poorly suited for more immersive, intuitive control schemes. The development of immersive computer-generated environments such as those used for gaming, social interaction, computer-aided design and other similar functions have highlighted the need for new input devices. Of particular note is the rise of augmented reality (“AR”) and virtual reality (“VR”) technology that enables users to be fully immersed in computer generated environments. AR and VR technology platforms are poorly suited for traditional input methods as they can break immersion and detract from the user's experience.

Often input device associated with VR have functions that are inherently unstable. Generally, the further a user moves from a center location, the easier it is to continue moving further because the user's center of gravity goes outside the bounds of the device. To counteract this, devices can be modified with the addition of ballast. This however still never truly corrects the problem as it often increases the resistance force. For example, the further the pivot point for movement is from a user's hips, the further the users having to move a users body in order to create the angle the MPU needs and still have a decent sensitivity and proper “dead-zone”. Also, somewhat susceptible to “signal drift.”

Further, the users have to move to create the movement, the longer it takes to adjust a user's movement or change movement directions, which makes the user's overshoot a user's preferred movement position. Depending slightly on the radius of the bottom, to go full-speed forward to full-speed backwards means the users have to move a users body around 22 inches.

The further the user's movement can put a user off-balance in VR, the more a user's body contemplates going on strike via way of VR induced motion sickness.

Fundamental VR Problems:
Does not address cable management/tangle
Does not address uncoupled look/move
Leaves room for improvement for a more compact operation envelope
Rubs and walks on flooring due to off axis rotation and no turntable

Another problem associated with VR systems is sickness caused by the vestibular system which provides the leading contribution to the sense of balance and spatial orientation for the purpose of coordinating movement with balance. As movements consist of rotations and translations, the vestibular system comprises two components: a first, which indicates rotational movements; and a second, which indicates linear accelerations. The vestibular system sends signals primarily to the neural structures that control eye movements, and to the muscles that keep an individual upright. Discoordination of these signals leads to motion sickness when using VR and AR systems.

These approaches were a bit more complex, but much more satisfying. Though the experience was less interesting for a crowd of VR curious onlookers to observe, it was eroding away at the real problems that faced VR. Traditionally, VR systems couple head movement to torso movement. For example, a user in a VR environment can for example travel down a sidewalk and wherever the user's looked, the user travels in the vision direction.

It is an object of the present teachings to overcome some of these problems and others with a system configured to measure relative movements of a user's torso with respect to ground.

### SUMMARY OF THE INVENTION

As specified in the Background Section above, there is a need for improved devices and methods for providing user input for controlling and or interacting with a computing device.

To overcome the afore mentioned problems, the system according to the present system measures the angle of the seated user's torso and feeds it back to the application so that the player axis is defined by torso angle. The head mounted display is then constrained to that player but “uncoupled” so that the view from the head mounted display is not affected by the torso angle, but only by the angle interpreted by the head mounted display. The torso angle information is presented as a part of the Human Interface device packet.

According to an alternate teaching, the system above can include a coupling mechanism configured to be coupled to one of a chest or a seating structure that keeps track of the rotational orientation of a seated user's torso. Each degree of rotational movement is added or subtracted from the original calibration position and can be as accurate as one degree. Optionally, when a user of a system initiates movement, the natural response of the user is to “lean” in the direction they wish to head within VR.

The design of system according to the above teachings allows for super-fast directional changes, because a properly trained user of a system does not have to translate their center of gravity to move any direction, they simply use core muscle movement to redistribute their weight to create the movement in VR. Optionally, the system utilizes a solution which the seating surface tilts at a point closer to the hips or seat of the user. This pivot location is critical as this approach never puts the user in a position of instability of falling.

According to the present teachings, the system allows a seated user's lower body function to allow rotational movement in a VR space. The system can incorporate electro-mechanical accelerometers to provide a visual representation through a multiple axis processing unit (MPU).

According to the present teachings, the system can provide to those users which are less sensitive to the sensations of VR movement, users can optionally just use a raw analog input gradient to create user movements and use the accelerometers for jump or some other function.

The present teachings are not to be limited in scope by the specific embodiments described herein. Indeed, various modifications of the teachings in addition to those described herein will become apparent to those skilled in the art from the foregoing description. Such modifications are intended to fall within the scope of the appended claims.

### BRIEF DESCRIPTION OF THE DRAWINGS

FIG. 1 shows a side view with a seated user and an illustration of motion on multiple axes in accordance with an embodiment of the disclosure;

FIG. 2 shows a flow chart of communication of the teaching with interactive computing devices in accordance with an embodiment of the disclosure;

FIG. 3 represent a chest mounted moving device according to the present teachings; and

FIG. 4 represents the circuit used in the chest mounted device shown in FIG. 3.

### DETAILED DESCRIPTION OF THE INVENTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

An embodiment is an input device comprising a user engaging portion; a plurality of positional sensors, the plurality of positional sensors further comprising; at least one pitch sensor; at least one yaw sensor; at least one roll sensor; and a coupling mechanism capable of coupling the input device to a computing device such that the sensing mechanisms can send data to the computing device.

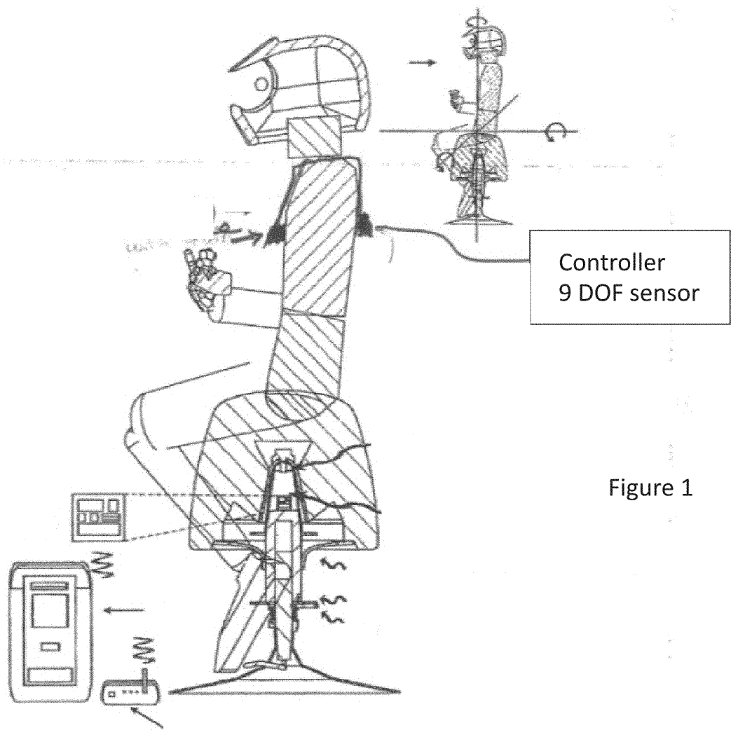

According to the teachings, FIG. 1 shows one embodiment of an input device of the present disclosure taking the form of a rotating sensor configured to measure the rotational and translational movement of the torso of a seated occupant, shown here in perspective and in profile. In this embodiment the seat is composed of stacking modules for reconfiguration by the end user and simple assembly for interactive control, user adjustment, and/or feature customization.

The combination of rotation of the seat with the user and the cushion is increased stability where the user's feet, legs, and torso partially embrace the rotating seat providing a leverage point for maintaining seating stability. A further advantage of this position is that the user is positioned to precisely rotate the seat with their legs straddling the side of the seat, with small pushes of the feet providing rotational force orthogonal to the axis of rotation and closely aligned the rotational freedom of the rotating base 1008. The rotational base 1008 and cushion platform 1005 in smaller or larger heights or profiles and with a detachable riser platform have the advantage of providing customizable dimensions to different user heights, weights, preferences, and interactive control capabilities. In this embodiment multiple base sensors are arranged in a configuration that permits multiple points of acquiring input for detection of the direction a user is leaning or rotating.

In additional detail, still referring to FIG. 1, interactive sensors have the advantage of allowing subtle user movements to be translated into motion input, direction of movement, and/or function selection in an interactive software application when employed with a computing device. The interactive sensors have the advantage of pressure sensitivity such that direction is derived through comparison of all sensors with intensity measured and translated into primitive data and commands for control of a computing device. Pressure on evenly placed sensors has the advantage of interpretation as a desire to move in the direction of the interpreted region, either directly on a sensor on based on weighted average between multiple sensors. Calibration of sensors is accomplished by a user sitting in multiple positions and making core body movements, with measurement spanning all sensors and retained by software and employed for later comparison. Feedback and interaction may also be provided by software input from these devices to interactive sensors such as those in for feedback including but not limited to sound, vibration, light, light effects, steam or smoke, and other interactive effects.

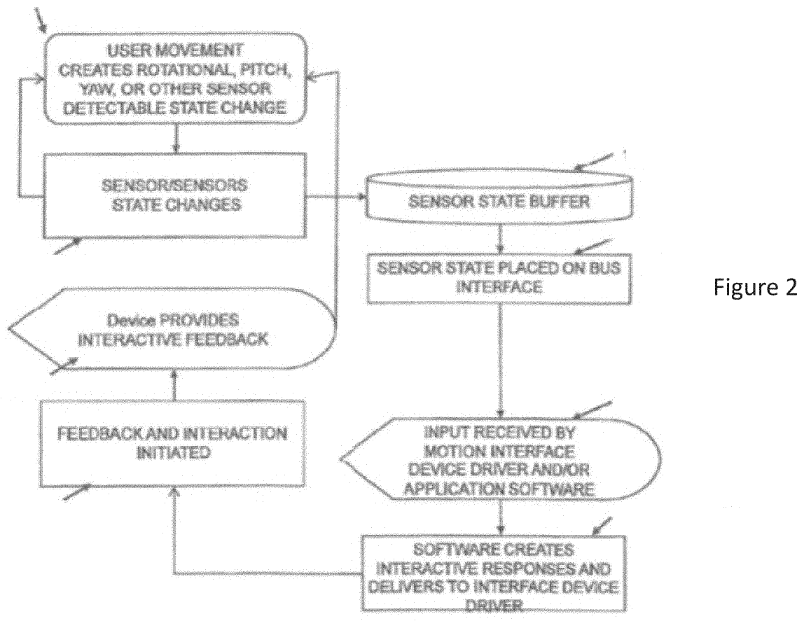

Referring now to FIG. 2, the construction details of the embodiments shown in FIG. 1. The sensor IMU components are coupled to a circuit board which are fixably coupled to a housing having a base. In some embodiments the base further comprises a plurality of grooves adapted to engage the stabilizing flange of a housing cover. The base and sensors in an interconnected sensor module stack together and may further be coupled a user' torso (front or back) using a harness or strap. Further, the housing can for instance be coupled to a rotating base or seatback of a chair. The modular design and construction of the teaching has the advantage that it permits users to exchange components rapidly to suit their desired mode of interaction and body position. The sensors collectively electronically sense pressure and motion to provide input to interactive software when connected by wire or wirelessly to a computing device including a smartphone, tablet, PC, gaming console or other computing devices known to those having skill in the art. The modular design has the added advantage that the integrated sensor module can be exchanged for different modes of control, feedback, or computer and game console compatibility.

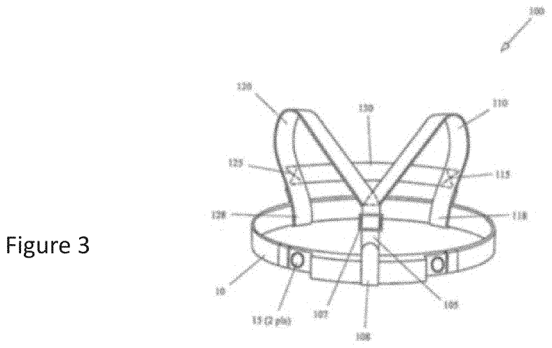

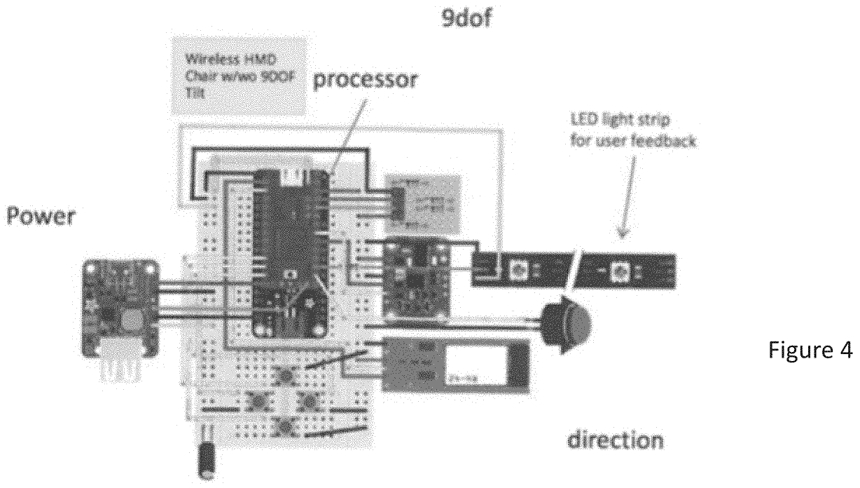

Referring now to FIG. 3, the construction details of the embodiments shown in FIGS. 1 and 2, the imu interfaces with a wired or wireless interface to interactive sensors FIG. 4 2006 and includes a wire harness, battery, power controller, multi-input processor, positional sensor, magnometer, gyroscope, external power connector and external wired and wireless interface for connection to personal computers, game consoles, mobile devices, handheld gaming devices and other computing devices.

Referring now to FIG. 1 there is shown the teaching with a user employing an embodiment of the teaching for interactive control while wearing a head mounted display for interaction with software experiences such as virtual reality, augmented reality, watching interactive video content, design, modeling, 3D computer aided design, or other forms of immersive content interaction. The user sits on the seat with support from the contoured seat back and in a saddle position with articulated knees and ankles and feet with the advantage of a secure and controlled body position while wearing a head mounted display or utilizing an immersive display. The user is additionally secured to the teaching with a security bracing with the advantage that if the user were to become unbalanced the security bracing would provide a physical cue helping the user to rebalance and physical restraint to prevent falling or imbalance.

In further detail, still referring to FIG. 1 there is shown the user seated with multiple axes of movement and motion control. Users may move freely utilizing hands, legs, and head movement through a motion tracking head mounted display to provide input through one or more motion control devices while simultaneously providing input by moving in multiple axes on the present teaching detected by interactive sensors and transmitted to an interactive computing device. Users may look in one direction providing multiple viewing axes utilizing a head mounted display while simultaneously utilizing motion control devices and simultaneously controlling input along seat multiple seat axes including yaw, pitch and roll through core body movements of the seat detected by interactive sensors.

In at least one embodiment the direction of the head, arms, and other body parts may also be tracked with motion control devices not physically connected to the seat and utilizing wired or wireless interfaces and combined electronically with interactive sensors modularly connected to the seat. The device according to the teachings has the advantage of allowing the user to utilize short core body movements of the lower body to control motion along multiple axes moving forward and backward for x axis pitch, left or right for z axis roll, and rotationally for y axis yaw. The device according to the teachings has the further advantage of detecting and calibrating for weight and sensing up and down user motion through interactive sensors FIG. 1. The device according to the teachings has the additional advantage of user control of motion input and through small movements while permitting a wide range of gesture-based input with hands, rotation, and emulation of walking and movement through core body movements along multiple axes while having a flexible seating position including a straddle positing conducive to balance control. The device according to the teachings has another advantage of allowing the user to maintain independent multiple viewing axes and multiple seat axes allowing users to provide input to interactive software for viewing direction independent of motion or interactive software function control.

Referring now to FIG. 1, there is shown a side cutaway view of the user wearing a head mounted display sitting in a straddle position. The motion of the user is accomplished through rotation and core movements creating forward and backward and left and right motion creating pivoting motion about a spherical center located below the top of the inner cup and outer cup and sensed by the sensor unit with the advantage of small movements providing motion while not upsetting the user's balance and while providing rapid control of interactive movement.

The sensitivity of the invention to user core body movements has the advantage of controlling interactive game movement with realistic response times and without latency for forward and backward walking, sideways walking, virtual object and vehicle control and any additional interactive control where body movement can serve as a control mechanism along multiple axes. Rotational movement is measured by the rotational sensor reading surface and an electronic sensor. Returning the user who may be slightly disoriented wearing a head mounted display to a neutral and upright position for stable control of the motion interface provided by the invention and other input devices is accomplished with the aid of the centering disk which has the advantage of returning the user with minimal effort to a neutral position and guided motion along multiple axes.

An electronic circuit board is mounted to, and shown within the chest with the advantage of creating wired or wireless interfaces between seat sensors and a computer, mobile device, handheld gaming device or other computing device. In some embodiments the electronic circuit board transmits signals using Wi-Fi and TCP/IP enabling an internet connection to a wired or wireless access point with the advantage of enabling motion output from the seat to be transmitted over the internet to local or remote computers and interactive computer software. In some embodiments, motion control devices and head mounted displays may be routed through the seat to the electronic circuit board through data connections such as USB and video connections such as HDMI and relayed to local or remote computers and interactive computer software with the advantage of utilizing the interface in the chair as a hub for motion control devices and head mounted displays.

Referring now to FIG. 2 there is shown a flow chart of the translation of movement from the input device into electronic signals and instructions for computing devices. The translation of movement is accomplished by electronic polling of sensors for state and changes and relaying these signals via an electronic interface including the embodiment of the electronic circuit board FIG. 1 to computers, mobile devices such as smartphones and tablets, handheld gaming devices, head mounted computing devices, head mounted computing devices with head mounted displays, and other computing devices. Feedback and interaction may also be provided by software input from these devices to interactive sensors such as those in FIGS. 1, 3 and 4 for feedback including but not limited to sound, vibration, light, light effects, steam or smoke, and other interactive effects. In some embodiments lighting of the cushion may indicate desired states of the user such as red for do-not-disturb or green for available.

User movement on the input device creates rotational, pitch, yaw or other sensor detectable state change 11010. Sensors of the input device undergo state change(s) 11020 as a result of user movement on the input device. The state change(s) are communicated to a sensor state buffer 11070. The sensor state is placed on a Bus interface 11080. The result is an input signal received by a motion interface device driver and/or application software 11100. As a result of the input signal the software creates interactive response(s) and delivers it to an interface device driver 11110. As a result feedback and interaction elements may be initiated 11040 causing the device to provide interactive feedback, such as haptic feedback, or other user feedback known to those having skill in the art. Following the provision of interactive feedback, and contemporaneous to the provision of interactive feedback, the device continues to detect user movement and convert that movement into detectable state changes in the device's sensors.

Components of an example machine able to read instructions from, for example, a non-transitory machine-readable medium and execute them in one or more processors (or controllers). Specifically, a machine in the example form of a computer system within which instructions (e.g., software or program code) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine for this configuration may be a mobile computing device such as a tablet computer, an ultrabook (or netbook) computer, a personal digital assistant (PDA), a cellular telephone, a smartphone, a web appliance, or like machine capable of executing instructions (sequential or otherwise) that specify actions to be taken by that machine. Further, while only a single machine is illustrated, the term “machine” shall also be taken to include any collection of machines that individually or jointly execute instructions to perform any one or more of the methodologies discussed herein.

The example computer system includes one or more processors (e.g., a central processing unit (CPU) and may also include a graphics processing unit (GPU), a digital signal processor (DSP), one or more application specific integrated circuits (ASICs), one or more radio-frequency integrated circuits (or chipset) (RFICs), a wireless fidelity (WiFi) chipset, a global positioning system (GPS) chipset, an accelerometer (one, two, or three-dimensional), or any combination of these). The computer system also includes a main memory and a static memory. The components of the computing system are configured to communicate with each other via a bus. The computer system may further include a graphics display unit (e.g., a plasma display panel (PDP), a liquid crystal display (LCD), glass display) which may be configured for capacitive or inductive touch sensitivity to allow for direct interaction with software user interfaces through the display 1310. The computer system may also include an alphanumeric input device (e.g., a keyboard), a cursor control device (e.g., a mouse, a trackball, a joystick, a motion sensor, or other pointing instrument), a storage unit, a signal generation device (e.g., a speaker), and a network interface device, which also are configured to communicate via the bus.

The storage unit includes a machine-readable medium on which are stored instructions (e.g., software) embodying any one or more of the methodologies or functions described herein. The instructions (e.g., software) may also reside, completely or at least partially, within the main memory or within the processor (e.g., within a processor's cache memory) during execution thereof by the computer system, the main memory and the processor also constituting machine-readable media. The instructions (e.g., software) may be transmitted or received over a network via the network interface device.

While machine-readable medium is shown in an example embodiment to be a single medium, the term “machine-readable medium” should be taken to include a single medium or multiple media (e.g., a centralized or distributed database, or associated caches and servers) able to store instructions (e.g., instructions). The term “machine-readable medium” shall also be taken to include any medium that is capable of storing instructions (e.g., instructions) for execution by the machine and that cause the machine to perform any one or more of the methodologies disclosed herein. The term “machine-readable medium” includes, but may not be limited to, data repositories in the form of solid-state memories, optical media, and magnetic media.

The input device which is intended to measure the change in angle of the chest or seat support with respect to the skeleton frame can have a first, a second, and third bumpers each radially disposed about the longitudinal axis. The plurality of sensors configured to detect the movement of the seat support is radially disposed about the longitudinal axis at a first radial distance from the longitudinal axis. The first and second bumpers are disposed at a second radial distance from the longitudinal axis, the second radial distance being less than the first radial distance. The third bumper is disposed at a third radial distance from the longitudinal axis, the third radial distance can be less than the first radial distance and different than the first radial distance.

Control mechanism for a seated occupant as described herein are also useful in an augmented reality environment. By providing a target surface for the occupant and display, and combining the rotary encoder, the occupant can be presented with an augmented world that is updating properly in accordance with the user's position. In such embodiments a rotary encoder detects the radial position/orientation of the user and communicates that information to the computing device rendering the augmented reality such that the computing device can adjust the position of the augmented reality content so that it matches the user's position in the real world. In this regard, the system can be used on a mobile platform such as a plane of a car. Accelerometers or optical sensors can be used to subtracted accelerations of the mobile platform from the input caused by movement of the user's chest.

Movement in VR and AR systems consist of rotations and translations. These movements are measured by the vestibular system comprises two components: a first, which indicates rotational movements; and a second, which indicates linear accelerations. The vestibular system sends signals primarily to the neural structures that control eye movements, and to the muscles that keep an individual upright. Discoordination of these signals leads to motion sickness when using VR and AR systems. In seated position's forward and rearward torso rotation must be minimized to prevent vertigo. In this regard, the systems described herein will function to provide a controller where a user can actuation movement within the VR system by swiveling his or her hips with respect to the floor and by leaving the torso generally upright. This will pave the head in a position + or −30 degrees from vertical and more preferable + or −15 degrees from vertical.

As described above, a plurality of first sensors configured to detect the movement of the seat support with respect the seat support surface and provide a signal thereof. An additional rotation sensor is provided which is configured to measure rotation of the skeleton support structure with respect to the floor. As described above, the seat support can include first, second, and third bumpers each radially disposed about the longitudinal axis to affect the kinematics of the rotation. The first and second bumpers can be disposed at a second radial distance from the longitudinal axis, the second radial distance being less than the first radial distance. Further, the third bumper is disposed at a third radial distance from the longitudinal axis, the third radial distance being less than the first radial distance and different than the first radial distance.

In embodiments, devices, systems and methods for improving elevation and or jump control include measuring the internal pressure of an enclosed seat volume and translating air pressure changes measured by sensor coupled to the IMU, to input signals suitable for the control of computer instructions, such as, for example a computer running a virtual reality or similar simulation. The air pressure of an enclosed volume of seating structure or room air pressure is measured, and corresponds to an axis of control. In use, the occupant/player applies or removes weight to/from the seat by supporting more or less of his or her mass, such as for example by having the user lift his or her body mass off of the seat, or rest his or her body mass more firmly onto the seat. A reservoir, load cell or other suitable structure in the seat detects a reduced or increased pressure to indicate an input along a gradient or specific points. This change in pressure is converted to a computer readable signal and is used as an input function to provide instructions to a computing device.

When used with a seat, this support member can be used as a zero balance seat for elevation control is shown and described where the height of posterior shelf/seat is measured, corresponding to an axis of control suitable for use as an input instruction on a computing device. Where there is a dead zone to accommodate for regular movement (like breathing or fidgeting), and then the ability for the user to support themselves more or less to thereby change the height of the seat.

In some embodiments additional input mechanisms are provided so that users can use additional motions and/or body parts to provide input. For example, users may use their arms, hands and or forearms on arm rests or other suitable structures in order to provide additional axis of controls or inputs. Users may also use their lower back, core angle open and closed (lean forward/lean backward while bending at the waist) and/or the use of seat back to control input. In some embodiments, users may also use their lower extremities to provide input. Such as, for example, the use of foot movements and/or gestures as an additional input or input modifier. By way of example, IMU tracked controllers attached to the feet of users, touch pad enabled floor mats, or the like may be used to capture foot movement and/or gestures. In some embodiments, users may provide input with the upper portion of their legs such as for example by using their inner thighs to engage structures on the seat such as a paddle, switch, axis input or the like. The movement of the user's arms can be used measured by a camera mounted on the chest mounted system described herein.

In each of the devices, a plurality of accelerometers can be used to differentially measure rotational or linear displacement for addressing and providing for variable movement speed controls. In embodiments a combination of analog tilt and switches create move modifier conditions, which could have the analogous function to pressing ‘shift’ or ‘control’ on a keyboard based on the angle of the seat. For example, the angle of the chair begins after a dead zone and then it tilts enough to create the slow to medium speed move, and then the switch creates the “shift” for “sprint” or a combination thereof where the switch could be made first for move, but still be in the analog dead zone, and then after the switch is made and more tilt is added to read outside of the dead zone, it could be interpreted as sprint. It may be desirable to use the tilt angle of the surface to imply relative velocity that would increase as angle increased, and then use the switch for a function such as jump. It may be desired for a user to tune their experience. This would require the ability to change fulcrum points, resistance, travel limits, and even sensitivity. Flexible joints that can be disposed between the seat and the seat support.

As shown on FIG. 3, a chest mounted device can be used to Measures the angle of the chest with respect to ground and provide an input signal (for example) to indicate W,A,S,D in a VR gaming type system to cause forward, left, right or reverse movement within the virtual environment, thus decoupling head and chest movement within a virtual or game space. The chest mount sensor cluster in the can measure the rotation of a body in a chair from nominal for the afore described systems. As shown in FIG. 1, the chest mounted device has a strap, which positions a housing, which holds a circuit board (see FIG. 4) against a user's sternum or back. The circuit board has a 6 or 9 degree of freedom accelerometer set, which measures the rotation of the user's torso with respect to the user's hips or a pivot point or line, which is below the seat surface. (see the many embodiments above). In this regard, the pivot point can be along the central axis of the seat and the user, or as shown in the many embodiments above, the pivot point or line can be radially displaced away from the centrally located axis of the user hips and body or the chair.

System according to the present teaching uses the chest or back mounted system to measure angular changes, using XYZ accelerometers, compass, atmospheric pressure sensors, and gyros, of the torso angle and position with respect to ground. The atmospheric pressure sensor (Barometer) allows measurement of body movement to allow the sensing of jumping or crouching by the user and adjust images in the head mounted display. This is compared and mixed with changes in the measured orientation of a head mounted display using for instance a Kalman filter to change the images from a first image to a second image within the head mounted display.

Optionally the chest mounted device can have a visual monitoring system with one or more ccd cameras, which look for the position of the hands or controller with respect to the chest mounted sensor cluster. This data is combined with head mounted visual monitoring systems which, in addition to IMU's within the hand controllers are used to place the hand controllers in image space with respect to the head or chest. Optionally, the chest and or imaging sensors can be used to locate and position the hands or hand controllers on images within the head mounted display. Optionally, in situations when the hands or hand controllers being tracked transitions from in a field of view to out of field of view of the visual monitoring system from the headset, then the locational information can be developed and used from the chest mounted imaging system. These methods can be used with outside-in imaging systems. In these systems, visual sensors (ccd cameras) can be placed on fixed locations about the user. When the user changes the position of the user's hands or head, these changes can be tracked by the sensors not directly coupled to the user's torso. When these outside in sensors are obstructed, chest mounted sensors can be used to track the movement or location of the hands.

Chest mounted visual monitoring system is particularly important when two users are in the same game space. This is because a secondary user can often be located between a first user and the exterior monitoring system. The chest strap can include a series of haptic motors to provide feedback to the user. These can be for instance distributed about the chest strap at 45 degree offset about the persons torso. These haptic motors can be driven through a multiplexed system because the haptics driver circuits can all have same address for their motor drivers.

The chest mounted device has a processor such by way of non-limiting example, as that in the sensor tile development kit STEVAL-STLK01V1. The kit provides circuits for motion, audio and environmental sensing and Bluetooth low energy. The circuit supports by the BLUEMICROSYSTEM1 and BLUEMICROSYSTEM2 software that allows connectivity via the ST BlueMS app, available for iOS and Android. The circuit of the device can have for example a STM32L476—32-bit ultra-low-power MCU with CortexM4F, a LSM6DSM—iNEMO inertial module: 3D accelerometer and 3D gyroscope, an Ultra-compact high-performance eCompass module: ultra-low power 3D accelerometer and 3D magnetometer. A MEMS nano pressure sensor: 260-1260 hPa absolute digital output barometer, a 64 dB SNR Digital MEMS Microphone, Bluetooth low energy network processor having a 50Ω balun with integrated harmonic filter, a 150 mA low quiescent current low noise LDO 1.8 V. The circuit can for example have a 2V-5.5 V power supply range. The circuit can have external interfaces: UART, SPI, SAI (Serial Audio Interface), I²C, DFSDM, USB, OTG, ADC, GPIOs. The chest mounted system incorporates a heart rate monitor, and audio input and output which can be used to transmit music and sound from the environment to the user, or as a platform or support a microphone for communications to other players. Optionally, the processor can be associated with a Software defined radio, which will allow the system to be updated to allow the transmission of data using varying protocols.

Disposed within or outside of the housing, can be a power supply in the form of a rechargeable Li ion battery. Also, coupleable to the system can be a plurality of motors that can give haptic feedback to the user, based on signaling cues on the VR or AR media. The sensitivity of the device according to the teachings to user core body movements has the advantage of controlling interactive game movement with realistic response times and without latency for forward and backward walking, sideways walking, virtual object and vehicle control and any additional interactive control where body movement can serve as a control mechanism along multiple axes. Rotational movement is measured by either detecting changes of the user using the accelerometers, or the rotational sensor reading surface and an electronic sensor in the seat (for example 7006) described above. The user who may be slightly disoriented wearing a head mounted display to a neutral and upright position for stable control of the motion interface provided by the device according to the teachings and other input devices is accomplished with the aid of the centering disk which has the advantage of returning the user with minimal effort to a neutral position and guided motion along multiple axes 7008.

An electronic circuit board mounted within the housing and shown within the with the advantage of creating wired or wireless interfaces between seat sensors and a computer (for example 7009 above), mobile device, handheld gaming device or other computing device. In some embodiments the electronic circuit board transmits signals using Wi-Fi and TCP/IP enabling an internet connection to a wired or wireless access point with the advantage of enabling motion output from the seat to be transmitted over the internet to local or remote computers and interactive computer software. In some embodiments, motion control devices and head mounted displays may be routed through the seat to the electronic circuit board through data connections such as USB and video connections such as HDMI and relayed to local or remote computers and interactive computer software with the advantage of utilizing the interface in the chair as a hub for motion control devices and head mounted displays.

When in use, the user is in a seated position on a chair with her feet on the ground. As described above, the user is allowed to rotate about a first axis that passes through and is generally perpendicular to a chair seat surface using her feet. As described above, this rotation can be measured using an encoder in the chair or can be measured using the 6 or 9 DOF accelerometers in the chest or back mounted device. Additionally, the 6 or 9 DOF accelerometers can be placed on a seat bottom or seat back. The circuit further measures the torso's rotation and translation of the user's torso about a second axis that is perpendicular to the seat's central rotational axis. This second axis (or plurality of second axes) are equal to or below the user's hips.

These rotation about the second axis are then translated into an input signal (for example) to indicate W,A,S,D in a VR gaming type system to cause forward, left, right or reverse movement. For example, when a user leans forward with respect to the second axis of rotation, the gaming or VR system receives for example a “W” which causes a user to “move forward” within the VR or media environment. Alternatively, when a VR or Game system is attempting to simulate fast movement within a vehicle, leaning back in the chair can make the user move forward in the VR space. This applies gravity onto the chest giving the user feeling of accelerating forward. By way of non-limiting example, this could simulate the G forces on a user for a race car accelerating or plane taking off a carrier, thus supplementing the user's experience.

In some embodiments, the pivot point is positioned high on the seat to facilitate ease of use, comfort and control. For example, Drones today are predominately four rotary wings (propellers) situated in a rectangle or square which can vary their power to maintain orientation, or move in any given direction or speed. Using an HMD to control the “eyes” of the device, the angle of the torso/chair to define forward, and each switch to provide the planar movement of the aircraft, and then in some embodiments, a hand or foot manipulated input device, as previously described herein to control additional controls integrated in the drone. Control schemes in some embodiments may include controlling the elevation of the drone based on pressure of a controlled volume or elevation change of the chair itself by the user supporting their weight more or less to upset or overcome the balance of a neutral weight balance system. Moving control to other parts of the body, rather than the hands, can allow for additional axis of control to be manipulated by the very accurate and tactile fingers, for example, systems such as fire control or robotic hands or manipulators. Control for using hybrid rotary wing/lift surface drone control (osprey-class device) is also contemplated.

Control of a seated user, as described herein are also useful in an augmented reality environment. By providing a target surface for the occupant and display, and combining the rotary encoder, the occupant can be presented with an augmented world that is updating properly in accordance with the user's position. In such embodiments a rotary encoder detects the radial position/orientation of the user and communicates that information to the computing device rendering the augmented reality such that the computing device can adjust the position of the augmented reality content so that it matches the seated user's position in the real world.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various implementations of the systems and methods described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, scripts, or program code) include machine instructions, for a programmable processor, and can be implemented in a high-level procedural and/or object-oriented programming language, and/or in assembly/machine language. The computer programs can be structured functionality in units referenced as “modules”. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Upon reading this disclosure, those of skill in the art will appreciate still additional alternative structural and functional designs for a system and a process for deep search in computing environments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. An input device comprising:
A head mounted display having one of an XYZ accel sensor, a gyro, a compass, and a video monitoring system positioned to visualize a user's hands when they are in a first and second location, and to produce a signal indicative of movement of the head mounted display;
a chest mount sensor platform, the sensor platform having at least one of a second XYZ accelerometer sensor, a second gyro, a second compass and a second video monitoring system positioned to visualize a user's hands when they are in a second and third location and produce a signal indicative of movement of the chest mounted sensor platform with respect to the floor and produce a second signal indicative of this movement;
a second controller configured to accept the first and second signals and produce a video signal which is displayed by the head mount display.

2. The input device according to claim 1, wherein the plurality of sensors configured to detect the movement of the chest are radially disposed away from a longitudinal axis defined by the torso.

3. The input device according to claim 2, further comprising first and second accelerometers disposed at a first radial distance from the longitudinal axis.

4. The input device according to claim 2, wherein the is configured to image a hand or a hand-held controller and produce a signal indicative of the relationship of the hand controller to the sensor platform.

5. The input device according to claim 1 wherein the analog sensor detects one of the change in resistance and a change in capacitance.

6. A method of displaying a three-dimensional virtual reality space for at least one user, the method comprising the steps of:
receiving a plurality of signals from a plurality of accelerometers couple to a users chest configured to measure a component of gravity, each accelerometer configured to provide a signal indicative of the gravity component;
calculate changes in at least one of the signals indicative of the component of gravity and provide an output signal indicative of the rotation of the seat support with respect the seat support surface;
acquiring three-dimensional graphics data associated with a geographic region to be used by the plurality of users in a shared manner and an update object whose state is updated according to an operation performable by each of the plurality of users;
functionally coupling the three-dimensional graphics data to a physics engine configured to physical rules to objects within the virtual reality dataset and a display engine is coupled to the physics engine to convert the dataset into first and second content streams; and
streaming a first content set from the three-dimensional graphics data to a VR headset and a second content set three-dimensional graphics data to the VR headset; and
changing the first content set in response to output signal indicative of the rotation.

7. An input device for a seated user, the input device comprising:
a floor engaging member having a floor engaging surface and a longitudinal axis generally perpendicular to the floor engaging surface;
a skeleton support structure having a seat support surface generally parallel to the floor engaging surface;
a seat;
a bearing disposed between the seat and the floor engaging member, configured to allow relative rotation of the skeleton support structure about the longitudinal axis with respect to the floor;
a pivot joint disposed between the seat and the seat support surface the pivot joint pivotably coupling the seat support surface to the seat in a manner which restricts the rotation of seat with respect to the skeleton support structure about the longitudinal axis and allows for the rotation of the seat in a plurality of directions perpendicular to the longitudinal direction;
a plurality of first sensors configured to measure changes in orientation of the torso of the seated user by measuring components of gravity indicative of movement of the seat support with respect the seat support surface and provide a signal thereof; and
a rotation sensor configured to measure rotation of the users torso with respect to the floor.

8. The input device according to claim 7, wherein the rotation sensor comprises a magnetometer.

9. The input device according to claim 7, wherein the plurality of first sensors are configured to detect the movement of the seat are radially disposed about the longitudinal axis at a first radial distance from the longitudinal axis.

10. The input device according to claim 7, wherein the plurality of first sensors are disposed adjacent the user's ribs.

11. The input device according to claim 7, wherein the plurality of sensors is coupled to one of a seat bottom and a seat back.

12. The input device according to claim 7, wherein the rotation sensor provides a signal indicative of a compass heading.

13. The input device according to claim 7 further comprising an actuator configured to apply a force to one of the support structures, and the seat support to signal a user.

14. The input device according to claim 7 wherein a floor engaging member having
a circuit to measure a component of gravity, each accelerometer configured to provide a signal indicative of the gravity component, said circuit configured to measure changes in at least one of the signals indicative of the component of gravity and provide an output signal indicative of the rotation of the occupant with respect the seat support surface.
